(19) United States
(12) Patent Application Publication
(10) Pub. No.: US 2013/0257058 A1
(43) Pub. Date: Oct. 3, 2013

(54) JET STREAM GENERATOR

(71) Applicant: Ronald Davenport Wilson, Liverpool (GB)

(72) Inventor: Ronald Davenport Wilson, Liverpool (GB)

(21) Appl. No.: 13/261,537

(22) PCT Filed: Jun. 16, 2011
(86) PCT No.: PCT/GB11/51122

§ 371 Date: Dec. 10, 2012

(30) Foreign Application Priority Data
Jun. 17, 2010 (GB) 1010222.6
May 26, 2011 (GB) 1108909.1

(51) Int. Cl. F03D 9/00

(52) U.S. Cl. CPC F03D 9/002
USPC 290/55; 415/148; 415/1

(57) ABSTRACT

An apparatus (10) for generating electrical power from wind energy (20) comprising: means (22) for forming at least two discrete jets of air (24) from an oncoming wind (20); a conduit (16); and at least one wind electricity turbine (14) located within the conduit (16), wherein the jets (24) are arranged to enter the interior of the conduit (16) from different directions and to converge towards a point or points (20) located within the conduit (16). The apparatus (10) may additionally comprise an inlet aperture (22), the inlet aperture being adapted to face towards, and to collect a stream of air from, an oncoming wind (20); and a manifold communicating with the inlet aperture (22) and being adapted to split the stream of air into a plurality of discrete jets (24), the manifold comprising a manifold outlet (28) for each jet (24); each manifold outlet (28) communicating with the interior of the conduit (16) and being arranged to cause their respective jets (24) of air to converge towards a point or points (30) located within the conduit (16). A method of generating electricity using the apparatus is also described.

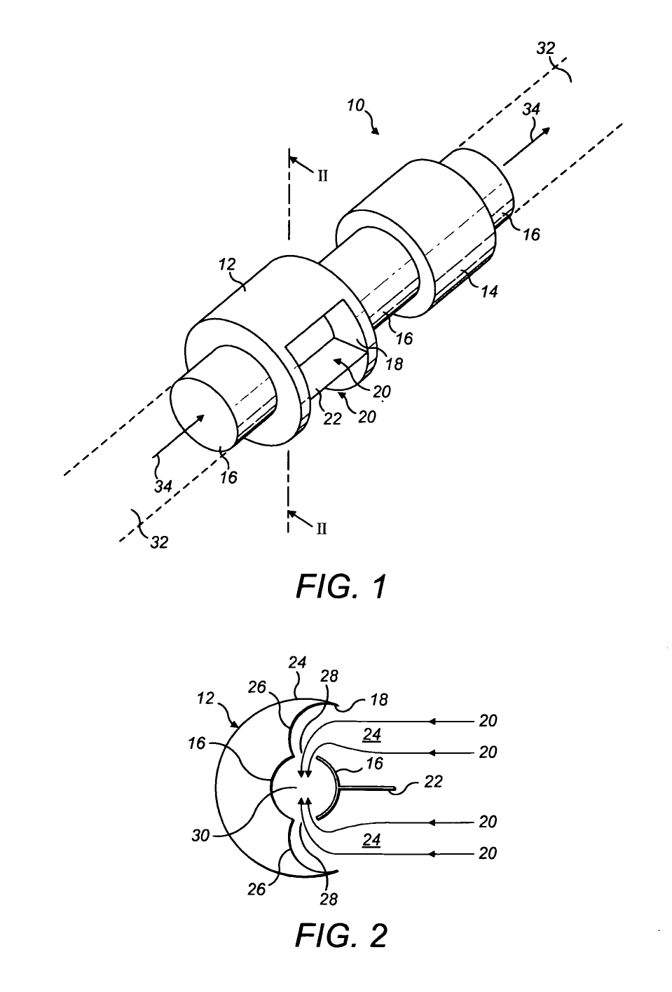

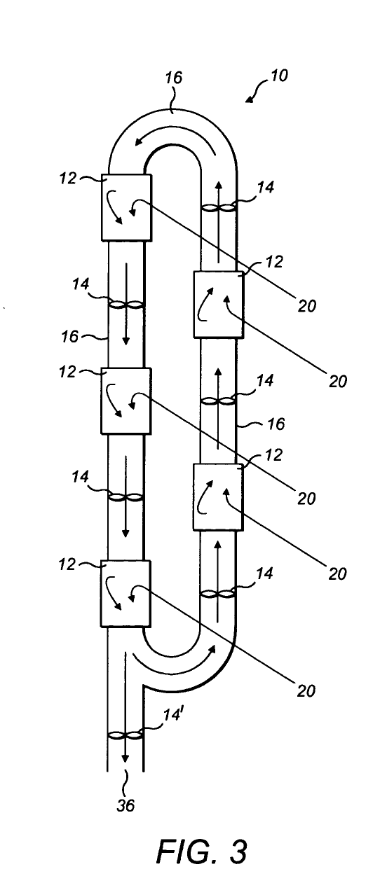

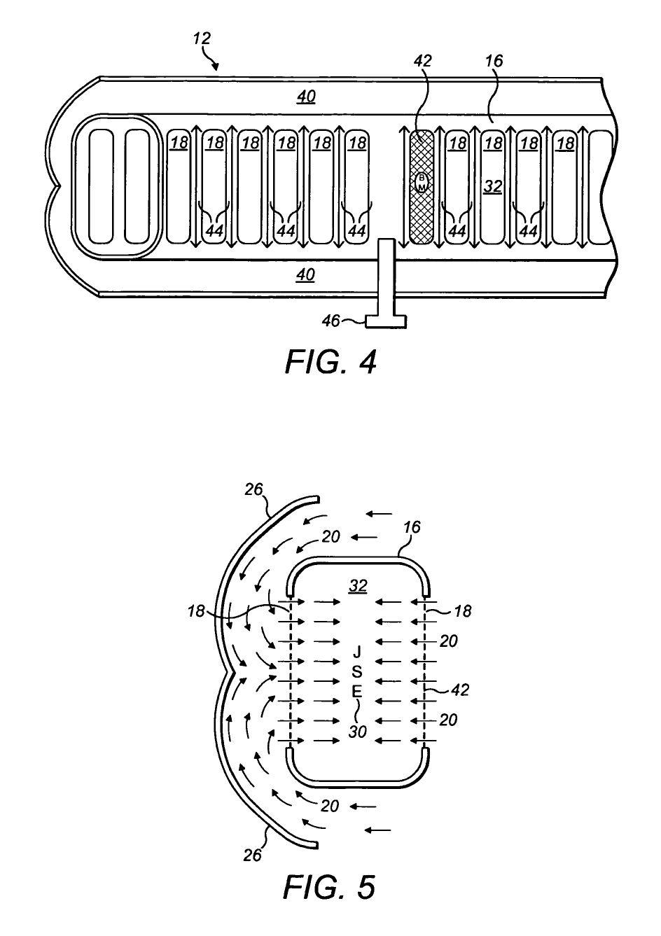

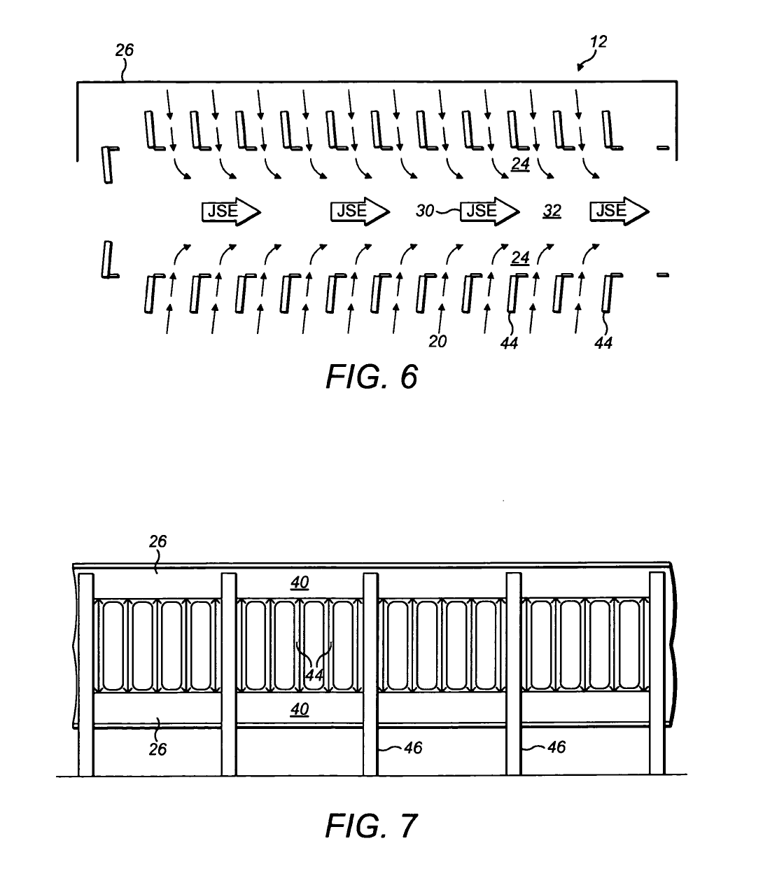

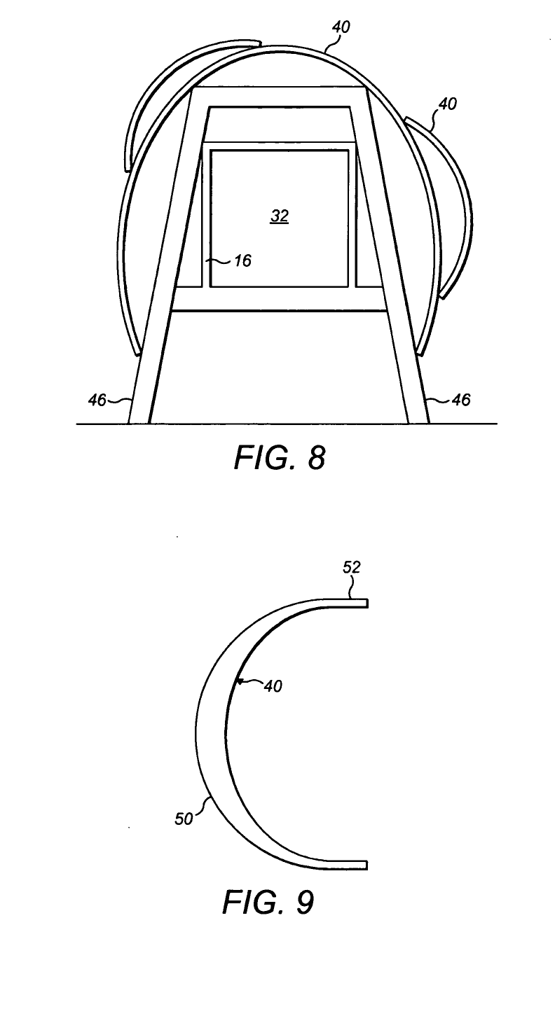

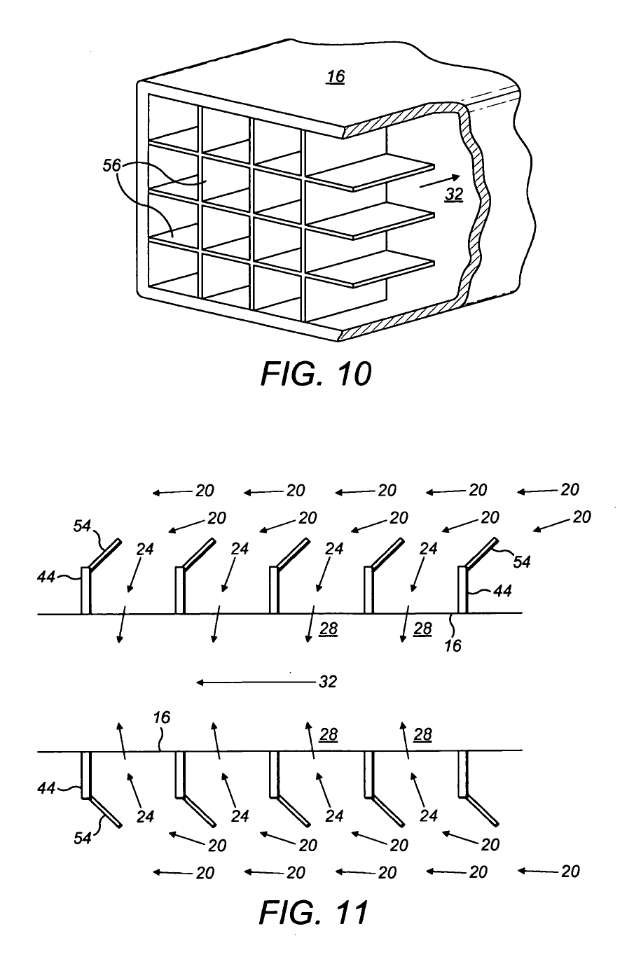

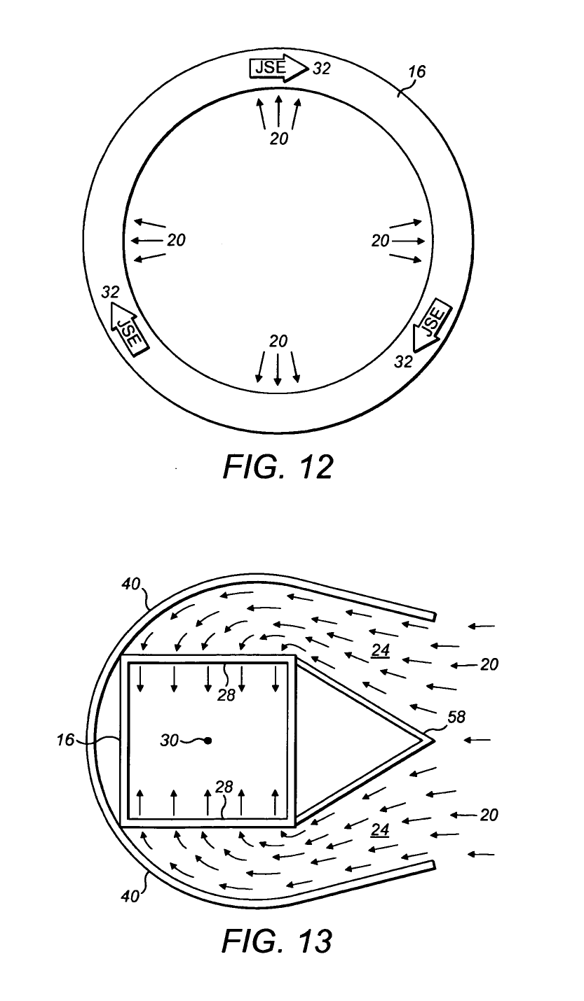

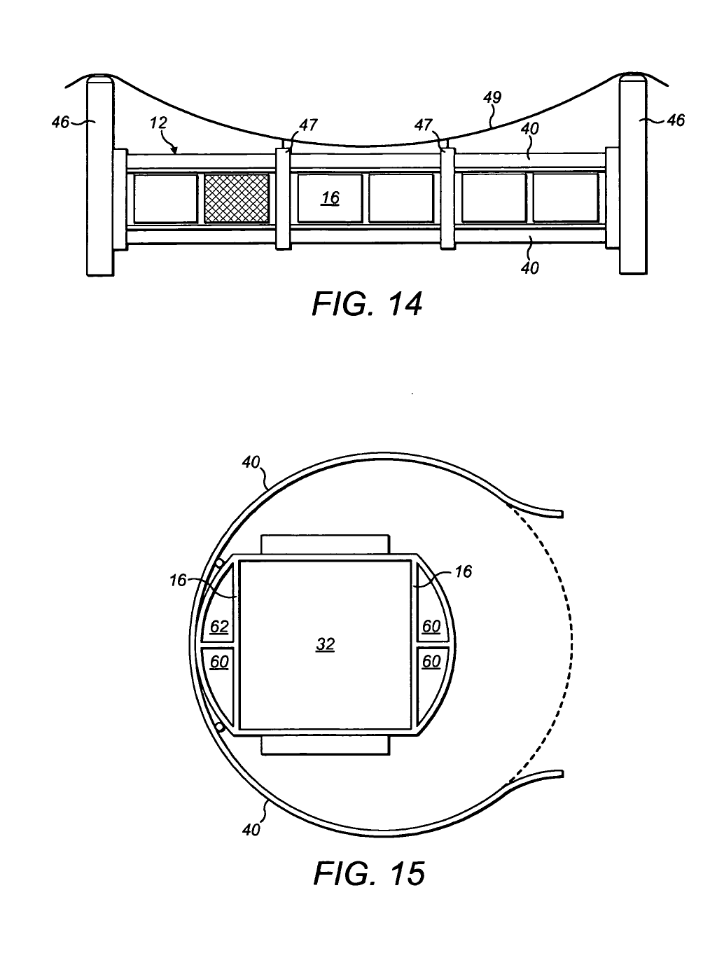

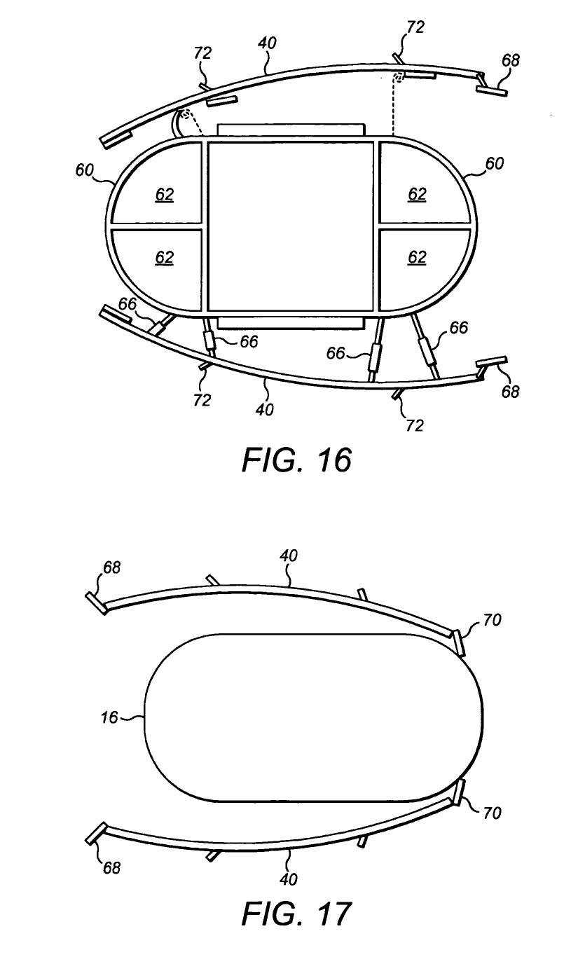

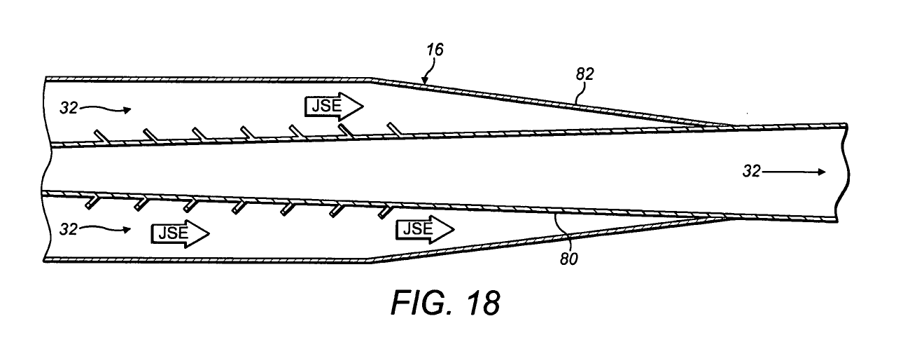

The Jetstream Generator is a device the main purpose of which is to enhance our capability to generate electricity from moving currents, predominantly in air, but which may also find an application in water currents. This report will direct its attention to issues arising in its application to air currents.

I am retired, but having a long standing interest in environmental issues, I was irritated by the general acceptance of claims that green energy (renewables) could never make more than a modest contribution to world energy needs. Wind and water currents hold far more energy than we need and are always on the move somewhere, there are of course easily identifiable problems; Location, Distribution, and Scale of Collection.

Paradoxically, “Scale” is at the same time the main advantage and disadvantage of my idea for an invention to address the shortfall of generation by current technologies. Firms working in the renewable energy field have done excellent work designing systems that they can build and install commercially, just as I would have done if I were a young man looking for a manufacturing opportunity. Unfortunately this approach is not producing the output needed to address environmental concerns. This led me to consider if an alternative method of energy capture could be developed that has the potential to generate sufficient energy to break our dependence on nuclear, and fossil fuels.

At first this was no more than my following a personal interest unfettered by considerations of commercial factors, or social impact. The principle behind my design solution came easily to me one rainy afternoon, but shocked to find that I may have designed something vitally important, I had no idea how to proceed. It seemed to be normal practice to seek a patent, which I have found to be a bit of a trial, and now I also need to find organisations that are interested in taking up my idea. As I have said I am retired and can therefore only look to licence development and production to others.

In theory the greater in size my Jet Stream Generator is constructed, the more efficient it will be, which brings location to the fore. Even as an environmentalist I would not want one in my back garden, and so the main potential for development would be found in those countries with wide open spaces. For the UK offshore developments would be much more acceptable, the costs would be greater but developments could combine wind, with wave and tidal power, and in some places coastal defence could be factored in. Multiple resource projects would have a clear advantage in terms of the continuity of supply.

Modem Wind Farms also exhibit a significant improvement in efficiency proportionate to the increase in size of the turbine blades. My design seeks, indeed needs, to outperform, even the largest, and by a factor of three times or more.

This is not an opportunity for a small firm, except perhaps in the development stage, full implementation will require a consortium of companies and governmental backing. The name Jet Stream Generator was chosen to reflect the physics of the principal design feature of the invention. Free standing wind turbines take energy from the compression of the wind against the turbine blades, large blades are more efficient which has led to the development of offshore wind farms. I have occasion to travel from Ormskirk to Formby in Lancashire and have a good view of turbines set side by side, parallel to the coast. This is a significant generation facility, and yet it is clear to see that the area of the blade surfaces is no more than 5% of the area described by a box encompassing the whole of the rotation of the blades of the wind farm. The Jet Stream Generator will attempt to collect energy from 100% of that area.

The efficiency of giant wind turbines is well known, whilst the efficiency of the Jet Stream Generator is not known, but if it is half as efficient then the output could be ten times greater. However, internal design features could see it outstripping wind farms even on this criterion.

It is impossible to collect 100% of the energy available to the collection area of the box I have described, not all of the energy will be able to enter the unit, as the diverted air must carry kinetic energy with it.

Whilst the aerodynamics will inevitably be cutting edge for a large system, the basic design is very simple, I think of it as a very large wind tunnel mounted on pylons and running parallel to the land or water above which it stands. The tunnel can be better described as a corridor for most of its length, but other profiles will also be employed to house or direct the resultant air flow to turbine systems. Aero foils, I have named Turbo Sails, in the form of large parabolic scoops are fitted above and below the corridor. The resulting construction will present a face to the wind equivalent to a box accommodating the rotation of the maximum number of free standing wind turbines that could be fitted into that area without overlap. Smaller units will of course be more practical to build, and could well give the required minimum efficiency gain. Whatever the final scale is, the Jet Stream Generator will present a gigantic sail area to the wind, allowing 100% of its kinetic energy to fall upon it.

There are other designs seeking to capture wind inside a tunnel or corridor in an effort to improve the take off at the turbines, all efforts are to be commended and it may be that theirs will be built and mine not, but there is a fundamental difference in operating principles which I believe sets my design apart. If a free standing turbine is described as a single stage generator, then the other designs could be described as two stage generators, as they simply funnel the wind to turbines to improve efficiency. The Jet Stream Generator is both multi stage and multi function.

There are a number of construction design options for building a Jet Stream Generator, but the physics applies to all equally. In the basic design entry ports in the corridor which face the wind, the primary intake, are opposed by ports to the rear. The turbo sails set above and below the corridor funnel wind to the rear to oppose the primary intake, louvers in the ports are set at an angle such that the resulting pressure will generate an air flow in the direction best suited to the operator. Normally the construction will face the prevailing wind direction, however the turbo sails can be moved or raised to either side of the corridor, and adjustable louvers will capture flow impacting at an angle, enabling units to work effectively in most wind conditions. Due to the pressure difference caused by the opposing intakes, the airflow in the corridor will accelerate and become faster than the external wind.

This is where I have experienced a significant degree of difficulty in gaining support, as, at first sight, everyone has seen my design as relying only upon the fluid dynamic effects of introducing wind into a corridor prior to taking off energy by passing it over a turbine. Other systems under development capture wind through ports and direct it into a corridor but in a linear or turbo linear fashion, my system uniquely brings the available current directly into opposition with itself, in order to create a pressure gradient in the tunnel which will result in an increase in the speed of flow along the tunnel. If this increased flow stemmed solely from fluid dynamic principals, then the resultant flow would be a little less than twice the speed of the external current. There would be a worthwhile advantage in this, as we could deliver “nearly twice as much energy” along a corridor of a particular size, compared to a system that does not produce a significant increase in air speed relative to the external wind. Higher flow speeds also give an advantage in turbine efficiency. But, as this advantage would be achieved with a small number of ports, there would be little to gain in building the huge systems we need to achieve our grand objective, if we rely solely upon fluid dynamics.

It is at this stage that the physics gets interesting, and has not proved to be obvious to everyone. If, not withstanding the limitations of fluid dynamics, we were to build a system of the size I have described, and we were to stand back on the windward side, it would take a form that could be likened to a gigantic sail. In a system collecting wind the pressure inside the corridor would prevent more air entering, unless the air inside the corridor speeds up, which will require more energy than can simply be provided by the free flow of the wind, nevertheless an enormous amount of additional energy is falling upon the sail area, and of course whilst energy can readily change its form, IT CANNOT BE LOST. The principal object of my design is to capture a significant proportion of this additional energy, which requires a transfer path that is feasible in terms of physics.

In my submission, I claimed that energy can be transferred into the corridor at atomic level, by which I meant from atoms outside of the corridor to atoms inside the corridor. We all experience in our everyday lives, heat energy travelling from atom to atom by conduction, and there is a branch of physics dealing with the effects of this transfer.

Paradoxically, there is no such thing as heat, what we respond to as heat is the rate of vibration of the atoms in any heated body, caused by the take up of energy, by each individual atom. Broadly, heat moves to the next atom, if that atom is vibrating more slowly. (This is an oversimplification for illustration purposes.)

Reviewers, considering my design only from the standpoint of fluid dynamic principals, have said that extra energy cannot enter the system at atomic level.

Engineers use the principals of Classical Physics in this field to make their calculations, even though Quantum Theory has revised our understanding of what may be happening on an atom to atom basis. But, as the calculations remain true to five places of decimals or more Classical Physics remains the standard for most practical applications. As all of the alternative designs I am aware of, rely on simple fluid dynamics, I can understand why someone may not look further than these principles. In reality, no energy enters any of the existing or proposed systems that is not derived at atomic or sub-atomic levels, after all wind and water currents are primarily driven by radiation from the sun.

Radiation falling upon a Wind Turbine, or any of the proposed alternatives, will make a measurable difference, but will not significantly add to or detract from electricity generation. What is critical to understanding the operation of my system is an appreciation that energy can readily change nature, method, and speed of transmission, and that this happens at the atomic level.

My design seeks to derive only perhaps 10% of it's output by virtue of simple kinetic flow into the device, the flow in the corridor however has to account for 100% of output, and to achieve this the air flow in the corridor will need to be accelerated by ten times. Thus providing for, ten times the volume of air to pass through the corridor over any given period. In effect then, I am seeking to create a micro climate in the form of a high speed wind within a corridor, and also to tap the energy implicit in this in as efficient a manner as possible. But, I am not designing turbines, my part is to set up the jet of air that will drive them, but for this to have a commercial use, I have had to include proprietary turbines in my design.

In this endeavour I am not restricted by any single discipline, the atoms and molecules comprised of in the atmosphere are accelerated to generate wind, in a variety of ways. Energy can also enter my invention in a variety of ways, kinetic flow, wave effects, and latent energy, being the most important.

If we ignore latent energy for the time being, the energy available to me is quantifiable in terms of the kinetic energy of the wind falling upon the sail area of my device. In accepting that only a proportion can enter the system based on fluid dynamics, we have to ask ourselves, what happens to the rest? The excess wind has to be deflected to enable it to pass over and under the device, this takes energy and the interaction causes a compression wave to form, and this might be described as Ultra Low Register Sound.

If one stands by a very large building in gusty conditions, compression waves sometimes achieve the human audio range. This can create a conduit for energy to pass into my corridor through the vibration of atoms one upon another in order to accelerate the flow of the column of air in the corridor, as this speeds up more air will enter enhancing the kinetic input. This is what I meant when I claimed that energy can enter the system at atomic level. We can also recall that conservationists were concerned about the welfare of birds, fearing they may be affected by low resister sound effects, emanating from wind farm turbines.

The reason for this is that a wind turbine captures the energy of the wind it deflects. Intuitively we would see this as a kinetic action/reaction, but it is more complicated than that, to achieve a purely kinetic transfer every atom would have to strike the turbine blade. Clearly this cannot happen, as atoms flowing along the blade will prevent the majority of atoms deflected from impacting upon it, therefore most of the energy must be transferred to the blades at atomic level, passing atom to atom into the blade. We see the cumulative effect of this, as pressure on the blade and make our calculation accordingly, but we must think differently when considering a column of air.

I first attempted to explain my concept by comparing the effect to a fleet of sand yachts racing along a beach, but as I have provided for an extra compression by virtue of the turbo sails a better analogy is squeezing a bar of soap to cause it to shoot away.

Sand yachts achieve better than 60 mph in relatively light winds, they are built on aerodynamic principles so far as sail design is concerned, but not so far as head on drag is concerned. Add on friction of the wheels on sand and the speed reached is counter intuitive. I have only seen sand yachts on film, but I have been on a big catamaran on holiday, great fun but not for the faint hearted, and when it is brought on to the wind you can hear the pick up, and the vessel bolts forward like a scalded cat. (Not that I have scalded any cats,) The transfer of energy through air has to be very quick.

The best demonstration of how incredibly efficient air is at transferring energy is music. If I am on the stage of the Royal Albert Hall and pluck a string on a Harp the note produced can be heard throughout the auditorium. That tiny input of energy will move every atom of air in the hall, the best part of 100 tons, and result in movement in the ears of the audience, and this at the speed of sound. The reason for this is heat, which of course is simply vibration of the atoms, the cycles of this vibration move so fast at normal temperatures, that the slightest impulse upon one atom can be transferred to the next atom almost instantly. I appreciate of course that a harmonic note will maintain integrity better than random pressure waves. But the physics of the transfer of energy remains true for both.

The effect I am looking for might be achieved if an inordinately long direct system is built, but in practice it is likely to be more practical to build a circulating system to give us an infinite loop.

The object of this is to facilitate a continuous collection capability in order that the optimum air speed can be generated in the corridor. As the air can pass through many cycles around the loop it can be exposed to an infinite number of opposed ports.

It is possible that the air flow in the corridor could achieve destructive levels, and so when a suitable air flow rate has been achieved we will then take off the extra energy flowing into the system. This will be achieved by installing turbines and generators inside the corridor, the number of units being determined by the size of the loop, and eventually practical experience. My design also allows for the use of an external, or exhaust, turbine and generator. The inclusion of an exhaust option simply satisfies an intuitive feeling, that a combination system will be more practical to operate.

I have indicated that my system will need to be more efficient than any of the alternative, operating or proposed systems. This is in recognition of the enormous development and building costs, entailed in a project of this ambition. The key to this is in saving the loss of energy as air passes from a turbine back into the exterior wind, air has to move quickly across a turbine, and consequently carries kinetic energy with it as it passes back into the general flow.

Alternatively, if when the system has achieved an optimum air speed in the corridor we are able to close the outlet, the air column will continue to circulate. The energy of the wind then impacting upon the system will seek to increase the speed of the air column, but as we will prevent this by taking this excess energy off with a series of in corridor turbines, there will then be no loss of energy as a result of an exhaust flow. The turbines could then be extracting 100% of the energy entering the system, less factors such as drag.

What about Latent Energy. In hot humid climates latent energy accounts for several times more energy than does the wind on the majority of days in the year. Left to its own devices it may form vast cumulus nimbus storm clouds, and generate large amounts of electricity to give spectacular displays of lightning, and on occasion terrifying tornadoes of immense power. If this can happen spontaneously, then if my system can collect enough hot humid air, in the way I have described, is it really beyond the wit of man to tap into the energy available. And, if we can we should.

I have suggested, in order to illustrate a possible commercial application, that compression and decompression, might be the key to harvesting this latent energy, and illustrated one option that might be suitable. I am aware however that there are some heat exchangers in the final stages of development that are so efficient as to defy belief, and if I provide the energy stream, I believe that someone will design the most efficient way of extracting it.

If we are able to extract energy from hot humid air, then to obtain the maximum volume we will have to maximise the use of exhaust generators, and build very long linear corridors rather than loop systems. As a conservationist, I have recognised that if we extract the energy from a large volume of humid air, we will obtain a significant volume of water as a by product. This could be crucially important in some regions.

I hope that this will be of help when evaluating my invention.
R D Wilson
3 Vicarage Close,
Lathom
Lancashire
L40 6LD
UK.

1. An apparatus for generating power from wind energy comprising: means for forming at least two discrete jets of air from an oncoming wind; a conduit; and at least one turbine located within the conduit, wherein the jets are arranged to enter the interior of the conduit from different directions, via multiple ports, and to converge towards a point or points located within the conduit.

2. An apparatus for generating electrical power as claimed in claim 1, wherein the turbine comprises a wind electricity turbine

3. An apparatus as claimed in claim 1, wherein the turbine is operably connected to a mechanical output shaft.

4. An apparatus for generating electrical power as claimed in claim 3, wherein the turbine is operably connected to any one or more of the group comprising: an electricity generator; a pump, and an electricity/energy storage unit.

5. An apparatus as claimed in any preceding claim, additionally comprising inlet apertures, such apertures being adapted to face towards, and to collect a stream of air from, an oncoming wind; and a manifold communicating with the inlet apertures and being adapted to split the stream of air into a plurality of discrete jets, the manifold comprising a manifold outlet for each jet; each manifold outlet communicating with the interior of the conduit and being arranged to cause their respective jets of air to converge towards a point or points within the conduit.

6. An apparatus as claimed in any preceding claim, wherein the conduit is adapted to constrain a moving column of air, the manifold outlets being arranged to direct their respective jets of air at an angle into or towards the moving column of air to transfer kinetic energy from the jets to the column of air, wherein the manifold outlets are arranged to cause the jets to converge towards a point lying substantially on a longitudinal axis of the conduit.

7. An apparatus as claimed in any preceding claim, wherein the manifold outlets are arranged to cause the jets to converge substantially perpendicularly to a longitudinal axis of the conduit.

8. An apparatus as claimed in any preceding claim, wherein the manifold outlets are arranged to cause the jets to converge at an angle to a perpendicular to a longitudinal axis of the conduit, the angle comprising any one or more of the group comprising: 0 to 90 degrees, 0 to 45 degrees, 0 to 35 degrees, 0 to 25 degrees, 0 to 15 degrees, 0 to 5 degrees.

9. An apparatus as claimed in any preceding claim, wherein the conduit has at least one conduit outlet located downstream of a point where a plurality of jets converge.

10. An apparatus as claimed in any preceding claim, comprising a plurality of inlets and manifolds arranged to communicate with a common conduit having conduit inlets located upstream of any point where a plurality of jets converge.

11. An apparatus as claimed in claim 10, wherein the conduit communicates in rotation with all conduit inlets, relative to the direction of flow, so as to make any description of loop or circuit such that it will form an endless conduit.

12. An apparatus as claimed in any preceding claim, further comprising means for controlling an airflow in any one or more of, an inlet aperture, a manifold, a manifold outlet, and/or the conduit.

13. An apparatus as claimed in claim 12, wherein the means for controlling comprises any one or more of the group comprising: a louver, a valve, a constriction, a baffle, a grille, and a vent or port, wherein the means for controlling any or all is adjustable.

14. An apparatus as claimed in any preceding claim, wherein the orientation of the inlets relative to the conduit is adjustable.

15. An apparatus as claimed in any preceding claim, wherein the means for controlling components identified in claims 12, 13, and 14, may be operated remotely or automatically using an actuator.

16. An apparatus as claimed in any preceding claim, incorporating facilities to channel any condensed water vapour from the conduit, and also facilities to direct surplus energy output to any suitable storage unit, e.g. pumped water storage, hydrogen production plant, heating suitable rock strata.

17. An apparatus as claimed in any preceding claim, wherein the conduit further comprises a constriction adapted to further accelerate the moving column of air.

18. An apparatus as claimed in any preceding claim, of the same design but constructed so as to be able to be deployed within a water current, splitting the flow into at least two separate currents and to bring them into opposition in a like manner to accelerate a current in a conduit, shall take all previous references to air or wind to include reference in context to water and water current, in this mode water turbines and generators will be fitted in substitution of wind turbines, and this shall also apply in respect of any other fluid or gas medium.

19. A method of generating electrical or mechanical power, as claimed in any previous claim, wherein the primary moving fluid comprises air or water: or any other suitable fluid medium e.g. derived from oil or gas extraction, or exhaust of industrial plant.
